(19) United States
(12) Patent Application Publication
(10) Pub. No.: US 2026/0328185 A1
(43) Pub. Date: Oct. 22, 2026

(54) SHAFT ICING SLEEVE FOR WIND TURBINE SHAFT

(71) Applicant: LiftWerx Solutions Inc., Cambridge (CA)

(72) Inventors: Nima AZADIZADEH, Cambridge (CA); Brandon CHABAI, Guelph (CA); Stephen LAFOREST, Georgian Bluffs (CA)

(21) Appl. No.: 19/115,856

(22) PCT Filed: Oct. 12, 2023
(86) PCT No.: PCT/CA2023/051349

§ 371 Date: Mar. 27, 2025

Related U.S. Application Data
(60) Provisional application No. 63/416,131, filed on Oct. 14, 2022.

(51) Int. Cl. F03D 13/10; F16B 4/00

(52) U.S. Cl. CPC F03D 13/122; F16B 4/00; F05B 2230/60

(57) ABSTRACT

A shaft icing tool for a shaft of a wind turbine has a sheet of flexible fabric that is bendable without breaking when cooled by contact with a solid coolant. At least one pocket is formed on to the sheet to hold one or more pieces of the solid coolant. The sheet is wrappable around a circumference of at least an end portion of the shaft so that the sheet is in contact with the end portion of the shaft and to distribute the solid coolant around the circumference so that the solid coolant cools the shaft around the circumference of the end portion to thereby shrink a diameter of the end portion of the shaft when the tool is wrapped around the end portion of the shaft. A securement element secures the tool on the shaft when the sheet is wrapped around the shaft.

### CROSS-REFERENCE TO RELATED APPLICATIONS

This application claims the benefit of U.S. Provisional Patent Application 63/416,131 filed Oct. 14, 2022, the entire contents of which are herein incorporated by reference.

### FIELD

This application relates to wind turbines, in particular to a tool for icing a shaft (e.g., a main shaft) of a wind turbine to assist with insertion of the shaft into another wind turbine component (e.g., a gearbox).

### BACKGROUND

In assembling a wind turbine, it is necessary to insert a main shaft of the turbine into a gearbox so that rotation of the main shaft caused by rotation of the rotor blades can generate electricity in the generator. Because tolerances between the main shaft and the gearbox are very tight (around 0.1 mm), “icing the shaft” to shrink the diameter of the main shaft really helps to improve the clearances, and makes the insertion much easier. Heretofore, icing the main shaft has been mostly a haphazard exercise without specialized tools that can be adapted to a variety of different shafts in different wind turbines.

There remains a need for a tool for icing a shaft, which can be efficiently applied to a variety of shafts of different diameters in order to assist with insertion of the shaft into a wind turbine component (e.g., a gearbox) or other shaft-in-component application.

### SUMMARY

A shaft icing tool for a shaft (e.g., a main shaft) of a wind turbine comprises: a sheet of flexible fabric that is bendable without breaking when cooled by contact with a solid coolant; at least one pocket formed on to the sheet of flexible fabric, the at least one pocket configured to hold one or more pieces of the solid coolant, wherein the sheet is wrappable around a circumference of at least an end portion of the shaft so that the sheet is in contact with the end portion of the shaft and to distribute the solid coolant in the at least one pocket around the circumference so that the solid coolant in the at least one pocket cools the shaft around the circumference of the end portion to thereby shrink a diameter of the end portion of the shaft when the tool is wrapped around the end portion of the shaft; and, a securement element for securing the tool on the shaft when the sheet is wrapped around the shaft.

A method of installing a shaft (e.g., a main shaft) in a component (e.g., a gearbox) of a wind turbine comprises: wrapping the tool described above around an end portion of the shaft, the tool provided with the solid coolant in the at least one pocket to cool the end portion of the shaft to thereby shrink the diameter of the end portion of the shaft; removing the tool from the shaft after the diameter of the end portion is sufficiently shrunken; and, inserting the end portion of the shaft with the shrunken diameter into the component.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a perspective view of an embodiment of a shaft icing tool showing the tool in an unwrapped configuration.

FIG. 2 depicts a perspective view of the tool of FIG. 1 from an opposite side.

FIG. 3 depicts the tool of FIG. 1 wrapped into a working configuration.

FIG. 4 depicts a perspective view of the tool of FIG. 1 wrapped around an end portion of a main shaft of a wind turbine.

FIG. 5 depicts an alternate perspective view of the tool of FIG. 1 wrapped around an end portion of a main shaft of a wind turbine.

FIG. 6 depicts a magnified view of the tool of FIG. 1 wrapped around an end portion of a main shaft of a wind turbine.

FIG. 7 depicts a perspective view of the tool of FIG. 1 wrapped around an end portion of a main shaft of a wind turbine with an insulating jacket wrapped around the tool.

FIG. 8 depicts an exploded view of FIG. 7.

FIG. 9 depicts a cross-sectional view of the end portion of the main shaft shown in FIG. 7 with the insulating jacket wrapped around the tool.

### DETAILED DESCRIPTION

The tool comprises a sheet of flexible fabric that is bendable without breaking, for example cracking, when cooled by contact with a solid coolant. Thus, the flexible fabric is cold resistant. The flexible fabric preferably comprises cotton, polyester, nylon, an elastomer (e.g., natural rubber, butyl rubber, etc.), or the like, or combinations thereof. In one embodiment, the flexible fabric comprises a cotton/polyester blend, for example a blend of 60% cotton by weight and 40% polyester by weight (e.g., the Challenger™ Fabric available from Klopman™ International). The flexible fabric preferably comprises a webbed layer that helps prevent cracking or other breaking of the fabric in cold temperatures. Challenger™ is a furniture-grade fabric that has a webbed layer which helps to prevent cracking of the fabric in cold temperatures. Testing of the Challenger™ fabric with dry ice has shown that this fabric is particularly useful.

At least one pocket is formed on to the sheet of flexible fabric. The at least one pocket is configured to hold one or more pieces of the solid coolant. The at least one pocket is formed on to an outer face of the sheet. The sheet can be wrapped around a circumference of at least an end portion of the shaft so that an inner face of the sheet is in contact with the shaft. Preferably, the entire circumference of end portion of the shaft is in contact with the sheet to maximize thermal contact between the shaft and the solid coolant loaded into the at least one pocket. Cooling of the shaft in this way shrinks a diameter of at least the end portion of the shaft until the end portion of the shaft is sufficiently shrunken to be inserted easily into the intended component. The sheet has a thickness that is thick enough to be durable while thin enough to maximize thermal contact between the shaft and the solid coolant and so that the sheet retains sufficient flexibility to wrap around the shaft. A sheet thickness in a range of 0.07-0.25 mm is generally suitable, although a sheet thickness outside this range may be suitable depending on the exact nature of the flexible fabric.

In some embodiments, the at least one pocket comprises at least one securable pocket flap for opening and closing the at least one pocket. The pocket flap may be connected to the sheet, to an edge of the at least one pocket or to both. The at least one pocket flap may be foldable over an edge of the at least one pocket to cover an opening into the at least one pocket. The at least one pocket flap may be secured in any suitable manner, for example by one or more of a hook-and-loop connector (e.g., Velcro™), a button, a snap, a pin, a tying lace, tape and the like. In some embodiments, the at least one pocket flap is monolithic with the sheet of flexible fabric and is foldable over the at least one pocket to close the at least one pocket. In some embodiments, the at least one pocket comprises a flexible material, for example the same flexible fabric used for the sheet. In some embodiments, the at least one pocket is formed onto the sheet by one or more of sewing, gluing or stapling, preferably sewing, the flexible material onto the sheet of flexible fabric.

Preferably, the at least one pocket comprises a plurality of pockets. The plurality of pockets is preferably distributed around the circumference of the end portion when the sheet is wrapped around the end portion of the shaft. Preferably, the pockets are evenly distributed along a length of the sheet so that the pockets are evenly distributed around the circumference of the end portion when the sheet is wrapped around the end portion of the shaft. Preferably, the pockets are arranged in a series of adjacent pockets along the length of the sheet. Preferably, each pocket is separated from adjacent pockets by a short segment of the sheet of flexible fabric to facilitate wrapping of the tool around the circumference of the shaft.

The securement element secures the tool on the shaft. The securement element can secure the tool to the shaft and/or secure the tool to itself whereby the tool is frictionally secured on the shaft. In some embodiments, the securement element secures portions of the tool together to frictionally secure the tool on the shaft when the sheet is wrapped around the shaft. The tool may be purpose-fitted to a particular shaft or can be adjusted to fit shafts of differing diameters. In some embodiments, the securement element is securable at any one of a plurality of locations on the tool so that the tool is securely wrappable around shafts of different diameters. The securement element comprises any suitable connector, for example one or more of a hook-and-loop connector (e.g., Velcro™), a button and button hole, a male and female snap connector, a pin (e.g., a safety pin), a tying lace, tape and the like. A hook-and-loop connector is preferred. In some embodiments, the sheet comprises an end tab comprising a connector for connecting the end tab to another location on the tool. In some embodiments, the end tab comprises one portion of a hook-and-loop connector and corresponding portions of the hook-and-loop connector are situated at intervals on the at least one pocket so that the end tab is securable at different positions on the tool. In some embodiments where the at least one pocket is a plurality of pockets, each pocket is equipped with the corresponding portion of the hook-and-loop connector so that the end tab can be affixed to any of the pockets once the tool is fully wrapped around the circumference of the shaft.

The solid coolant comprises any substance that can be cooled to become a solid at a temperature that is sufficient to induce diameter contraction of a shaft of a wind turbine. The solid coolant preferably comprises, for example, ice, dry ice, frozen propylene glycol, cryogenically cooled bars of metal (e.g., stainless steel) and the like. Dry ice (i.e., solid carbon dioxide) is preferred. Thus, preferably the flexible fabric can withstand dry ice temperatures (about −80 °C) without breaking, for example cracking, while remaining flexible enough to be wrapped around the circumference of the shaft. In particularly preferred embodiments, the tool is a fabric tool that is used to hold dry ice around a shaft in a wind turbine.

In some embodiments, the tool comprises an external thermal cover (i.e., an insulating jacket) which can be applied, especially in hot climates, in order to reduce external heat from impacting the solid coolant. In some embodiments, the external thermal cover comprises an insulating jacket fittable around the at least one pocket when the tool is wrapped around the shaft. In some embodiments, the insulating jacket comprises an insulating cap and an insulating sock. In some embodiments, the insulating cap is positionable at an end of the shaft and the insulating sock is fittable over the insulating cap and the at least one pocket to hold the insulating cap at the end of the shaft when the jacket is fitted over the at least one pocket. The insulating cap covers an open end of the tool when the tool is wrapped around the shaft. The insulating sock provides further insulation at the end of the shaft and insulates the at least one pocket from the external environment to minimize heat transfer from the external environment into the solid coolant thereby increasing the effective service life of the solid coolant.

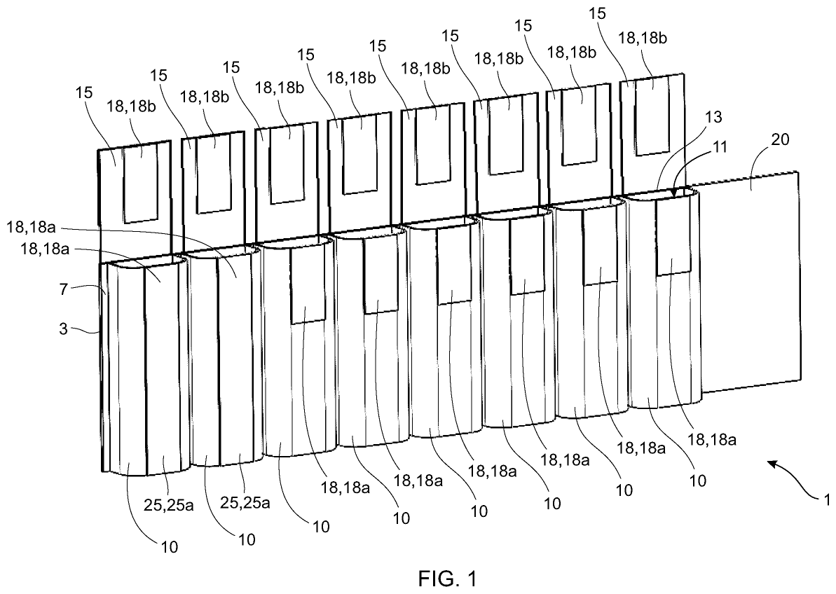

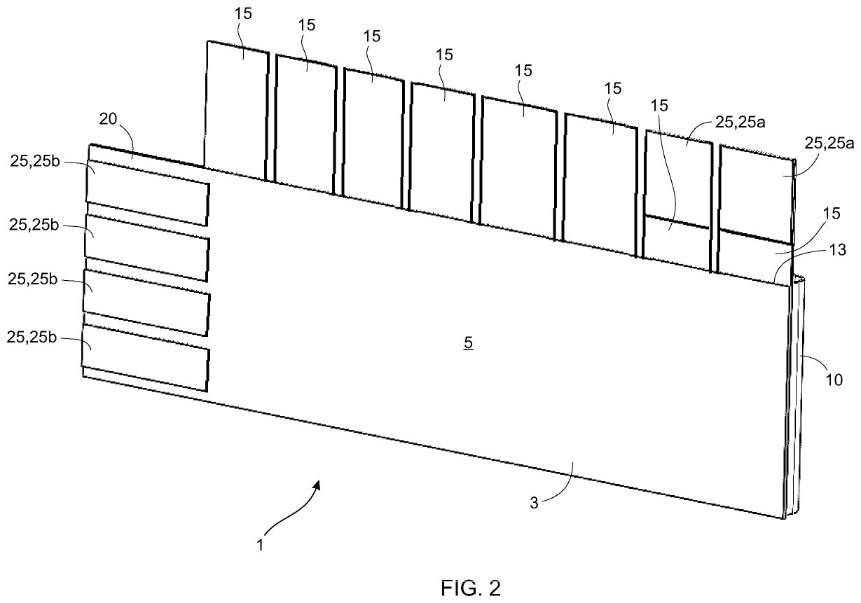

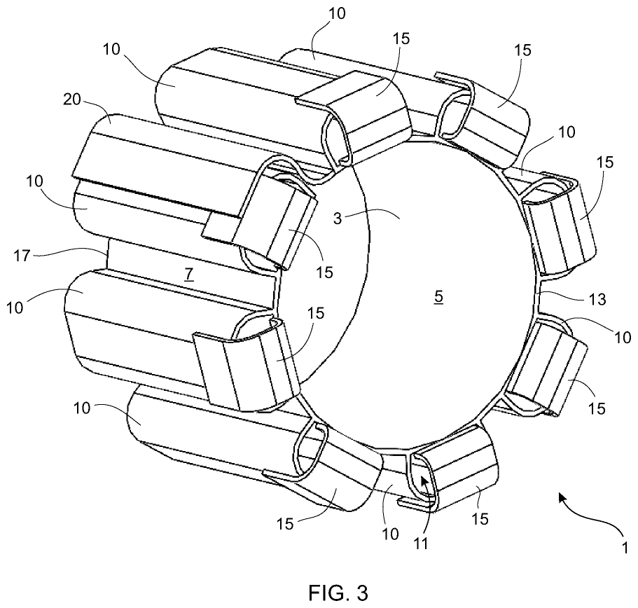

The Figures illustrate a preferred embodiment of a shaft icing tool 1. The illustrated shaft icing tool 1 comprises a sheet 3 of cold-resistant flexible fabric having an inner surface 5 (see FIG. 2) and an outer surface 7 (see FIG. 1). A series of pockets 10 are sewn onto the outer surface 7 of the sheet 3, the pockets 10 having pocket openings 11 (only one labeled) through which solid coolant (e.g., blocks of dry ice) can be inserted into the pockets 10. The pockets 10 comprise the same cold-resistant flexible fabric as the sheet 3. The pockets 10 are lined up in series along a length of the sheet 3 with all of the pocket openings 11 facing the same direction toward a lateral edge 13 of the sheet 3. The pockets 10 comprise pocket flaps 15 extending from the lateral edge 13 of the sheet 3. The pocket flaps 15 are monolithic with the sheet 3 and therefore comprise the same cold-resistant flexible fabric as the sheet 3. Folding the pocket flaps 15 over at the lateral edge 13 causes the pocket flaps 15 to cover the pocket openings 11 thereby closing the pockets 10 (see FIG. 3). The folded-over pocket flaps 15 are securable to the pockets 10 by first hook-and-loop connectors 18 whereby the pockets 10 are provided with one portion 18a of the first hook-and-loop connectors 18 and the pocket flaps 15 are provided with the other portion 18b of the first hook-and-loop connectors 18.

As best seen in FIG. 3, the pockets 10 are separated on the outer surface 7 of the sheet 3 by sheet segments 17 (only one labeled) to facilitate wrapping the tool 1 into a cylindrical form (see FIG. 3). The tool 1 further comprises an end tab 20 that is monolithic with the sheet 3 and is an extension of the sheet 3 that extends longitudinally beyond the pockets 10, i.e., there is no pocket sewn on to the end tab 20. The end tab 20 serves to facilitate securing the tool 1 in the cylindrical form with a securement element when the tool 1 is wrapped into the cylindrical form. The securement element comprises second hook-and-loop connectors 25 whereby the inner surface of the end tab 20 is provided with one portion 25b of the second hook-and-loop connectors 25 and the outer surfaces of the two pockets 10 at the opposite end of the sheet 3 from the end tab 20 are provided with the other portion 25a of the second hook-and-loop connectors 25. Also, the two pocket flaps 15 of the two pockets 10 at the opposite end of the sheet 3 from the end tab 20 are also provided with the other portion 25a of the second hook-and-loop connectors 25, where the other portion 25a of the second hook-and-loop connectors 25 are provided on the opposite surface of the two pocket flaps 15 from the other portion 18b of the first hook-and-loop connectors 18. When the tool 1 is wrapped into the cylindrical form, the portion 25b of the second hook-and-loop connectors 25 engage the other portion 25a of the second hook-and-loop connectors 25 to secure the tool 1 in the cylindrical form. Depending on the diameter of the shaft around which the tool 1 is wrapped, the portion 25b of the second hook-and-loop connectors 25 engages the other portion 25a of the second hook-and-loop connectors 25 on one or both of the two pockets 10 at the opposite end of the sheet 3 from the end tab 20. In this way, different diameter shaft can be accommodated. Further accommodation for smaller shaft diameters can be made by adding the other portion 25a of the second hook-and-loop connectors 25 to more of the pockets 10.

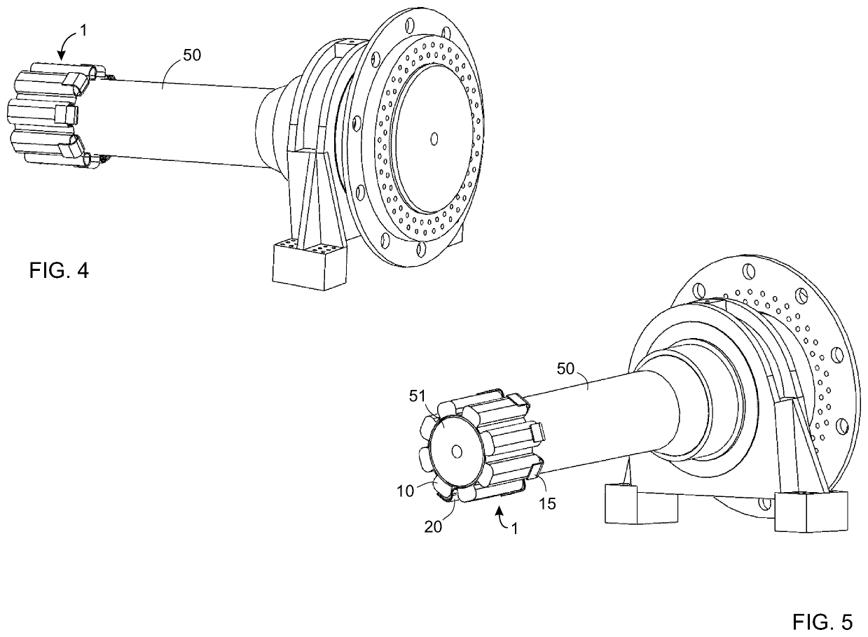

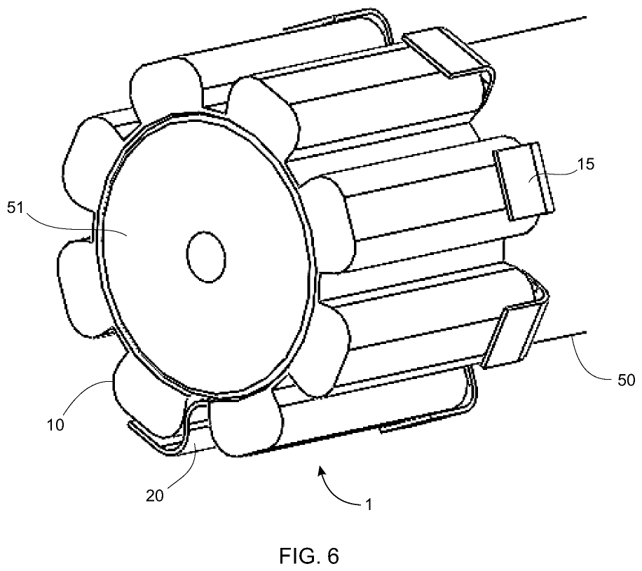

With specific reference to FIG. 4, FIG. 5 and FIG. 6, to cool an end portion 51 of a main shaft 50 of a wind turbine in order to shrink a diameter of the end portion 51 for insertion into a gearbox of the wind turbine, the end portion 51 is tightly wrapped with the shaft icing tool 1 to frictionally secure the tool 1 around a circumference of the end portion 51. The solid coolant can be inserted into the pockets 10 before or after wrapping the tool 1 around the end portion 51, but the insertion of the solid coolant is preferably done before wrapping because the pockets 10 are less accessible once the tool 1 is wrapped around the shaft 50. Once the diameter of the end portion 51 is sufficiently shrunken, the tool 1 is removed from the shaft 50 and the end portion 51 of the shaft 50 is inserted into the gearbox.

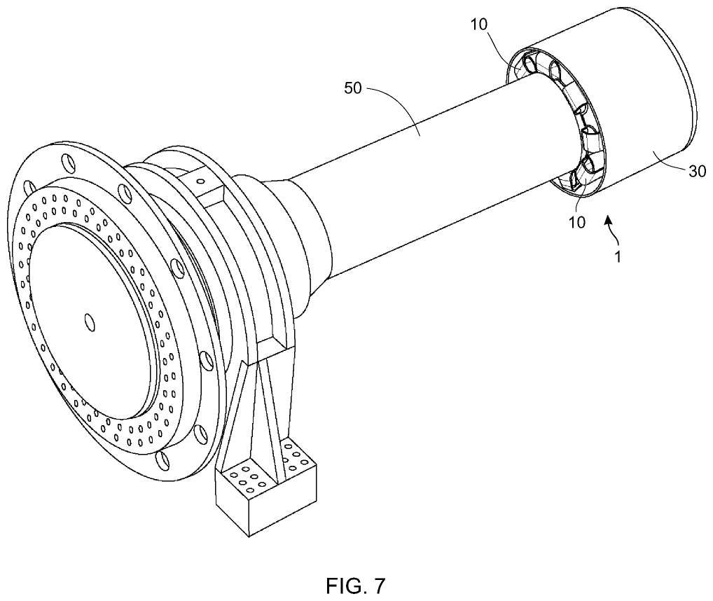

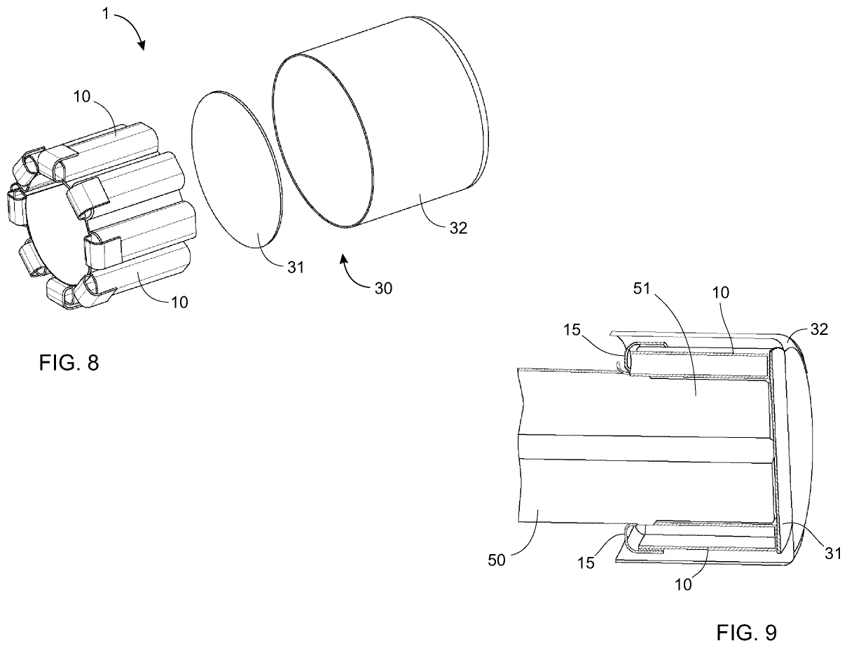

With specific reference to FIG. 7, FIG. 8 and FIG. 9, the shaft icing tool 1 can further comprise an insulating jacket 30 fittable around the pockets 10 when the tool 1 is wrapped around the shaft 50. The insulating jacket 30 comprises an insulating cap 31 and an insulating sock 32. The insulating cap 31 comprises a disc having a diameter sufficient to cover an open end of the tool 1 when the tool 1 is wrapped around the end portion 51 of the shaft 50. The insulating sock 32 comprises a cylindrical body closed at one end. The insulating cap 31 sits over an end of the shaft 50 and an open end of the tool 1. The insulating sock 32 is slid over the insulating cap 31 and pockets 10 to hold the insulating cap 31 in place and to insulate the pockets 10. The insulating jacket 30 or any one of the components thereof may be made from a rigid material or a flexible material. A rigid material provides extra security and strength, while a flexible material, especially a resilient material, provides improved formability around the pockets. The insulating jacket 30 is particularly useful in hot climates to extend the service life of the solid coolant in the pockets 10.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A shaft icing tool for a main shaft of a wind turbine, the tool comprising:
a sheet of flexible fabric that is bendable without breaking when cooled by contact with a solid coolant;
at least one pocket formed on to the sheet of flexible fabric, the at least one pocket configured to hold one or more pieces of the solid coolant, wherein the sheet is wrappable around a circumference of at least an end portion of the shaft so that the sheet is in contact with the end portion of the shaft and to distribute the solid coolant in the at least one pocket around the circumference so that the solid coolant in the at least one pocket cools the shaft around the circumference of the end portion to thereby shrink a diameter of the end portion of the shaft when the tool is wrapped around the end portion of the shaft; and,
a securement element for securing the tool on the shaft when the sheet is wrapped around the shaft.

2. The tool of claim 1, wherein the at least one pocket comprises a plurality of pockets distributed around the circumference of the end portion when the sheet is wrapped around the end portion.

3. The tool of claim 1, wherein the at least one pocket comprises at least one securable pocket flap for opening and closing the at least one pocket.

4. The tool of claim 1, wherein the securement element secures portions of the tool together to frictionally secure the tool on the shaft when the sheet is wrapped around the shaft.

5. The tool of claim 1, wherein the securement element is securable at any one of a plurality of locations on the tool so that the tool is securely wrappable around shafts of different diameters.

6. The tool of claim 1, wherein the securement element comprises a hook-and-loop connector.

7. The tool of claim 6, wherein the sheet comprises an end tab comprising one portion of the hook-and-loop connector and corresponding portions of the hook-and-loop connector are situated at intervals on the at least one pocket so that the end tab is securable at different positions on the tool.

8. The tool of claim 1, wherein the solid coolant comprises dry ice.

9. The tool of claim 1, wherein the at least one pocket comprises the same flexible fabric as the sheet.

10. The tool of claim 1, wherein the flexible fabric comprises a webbed layer and a blend of 60% cotton and 40% polyester.

11. The tool of claim 1, further comprising an insulating jacket fittable around the at least one pocket when the tool is wrapped around the shaft.

12. The tool of claim 11, wherein the jacket comprises an insulating cap and an insulating sock, the insulating cap positionable at an end of the shaft and the insulating sock fittable over the insulating cap and the at least one pocket to hold the cap at the end of the shaft when the jacket is fitted over the at least one pocket.

13. A method of installing a main shaft in a gearbox of a wind turbine, the method comprising:
wrapping the tool as defined in claim 1 around an end portion of the main shaft, the tool provided with the solid coolant in the at least one pocket to cool the end portion of the shaft to thereby shrink the diameter of the end portion of the shaft;
removing the tool from the main shaft after the diameter of the end portion is sufficiently shrunken; and,
inserting the end portion of the shaft with the shrunken diameter into the gearbox.

14. The tool of claim 1, wherein:
the at least one pocket comprises a plurality of pockets distributed around the circumference of the end portion when the sheet is wrapped around the end portion;
the at least one pocket comprises at least one securable pocket flap for opening and closing the at least one pocket;
the securement element secures portions of the tool together to frictionally secure the tool on the shaft when the sheet is wrapped around the shaft; and,
the securement element is securable at any one of a plurality of locations on the tool so that the tool is securely wrappable around shafts of different diameters.

15. The tool of claim 14, wherein the sheet comprises an end tab comprising one portion of the hook-and-loop connector and corresponding portions of the hook-and-loop connector are situated at intervals on the at least one pocket so that the end tab is securable at different positions on the tool.

16. The tool of claim 15, further comprising an insulating jacket fittable around the at least one pocket when the tool is wrapped around the shaft, wherein the jacket comprises an insulating cap and an insulating sock, the insulating cap positionable at an end of the shaft and the insulating sock fittable over the insulating cap and the at least one pocket to hold the cap at the end of the shaft when the jacket is fitted over the at least one pocket.

17. The tool of claim 16, wherein the solid coolant comprises dry ice.
